(19) United States
(12) Patent Application Publication
(10) Pub. No.: US 2018/0024854 A1
(43) Pub. Date: Jan. 25, 2018

(54) TECHNOLOGIES FOR VIRTUAL MACHINE MIGRATION

(71) Applicant: INTEL CORPORATION, Santa Clara (CA)

(72) Inventors: Wei WANG, Shanghai (CN); Yaozu DONG, Shanghai (CN); Yang ZHANG, Shanghai (CN)

(21) Appl. No.: 15/552,407

(22) PCT Filed: Mar. 27, 2015
(86) PCT No.: PCT/CN2015/075202

§ 371 Date: Aug. 21, 2017

(51) Int. Cl. G06F 9/455; G06F 9/50; G06F 12/1027

(52) U.S. Cl. CPC G06F 9/45558; G06F 12/1027; G06F 9/5088; G06F 2009/4557; G06F 2009/45583; G06F 2212/657

(57) ABSTRACT

Technologies for virtual machine migration are disclosed. A plurality of virtual machines may be established on a source node at varying tiers of quality-of-service. The source node may identify a set of virtual machines from the plurality of virtual machines having a lower or lowest tier of quality-of-service. Additionally, the source node may perform a pseudo-migration for each of the virtual machines of the identified set to determine a dynamic working set for each corresponding virtual machine. The source node may select a virtual machine for migration based on the dynamic working set. The pseudo migration may include emulation of a pre-copy phase of a corresponding live migration to identify the number of dirty memory pages likely to result during the corresponding live migration of the corresponding virtual machine.

### BACKGROUND

Virtualization technology plays an important role in computing, and particularly cloud and data center computing. Virtual Machine (VM) live migration is an advantageous feature of virtualization and refers to the process of moving a running VM and all associated applications between different physical machines without disconnecting the client or application. Memory, storage, and network connectivity of the virtual machine may be transferred from a source (host) machine or node to a destination machine or node. General benefits of VM live migration include the enablement of dynamic load balancing, enhancing server consolidation and facilitating server maintenance.

Current VM live migration technologies are based in part on managing the use of the bandwidth for live migration by configuring a quality-of service (QoS) policy to limit TCP traffic used for live migration. This is typically done to ensure that network traffic does not exceed a set limit. VMs in a multitier computing architecture may have functions that are logically separated, where each function may have different requirements in terms of resource access, data segregation and security. For example, a three-tier architecture may comprise a presentation tier, an application or data access tier, and a database tier.

As VMs may run with different QoS requirements, VM live migration typically selects a high level QoS (e.g., tier 3) for the highest level VM to migrate data to a destination node that has available resources. In many cases, the high-tiered VM will suffer from significant performance losses during migration time due to extra resource allocation (e.g. CPUs, network bandwidth) attributed to the migration process. Additionally, dirty memory issues may cause further resource allocation issues to arise during the migration process. Typical migration strategies include a pre-copy phase and a stop-and-copy phase. In the pre-copy memory migration phase, a high level tool stack (e.g., Openstack) typically copies all the memory pages from the source node to the destination node while the VM is still running on the source node. If some memory pages are updated (become “dirty”) during this process, they will be re-copied until the stop-and-copy phase is entered. If a writable working set of a selected VM is sufficiently large, the migration process will keep iteratively copying dirty memory pages to the point where the service requirements cannot be met due to excessive downtime and the migration process will be prevented from going into the stop-and-copy phase, in which the VM is stopped and the remaining memory pages are copied to the destination node.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates a simplified block diagram of at least one embodiment of a system for migrating virtual machines including a plurality of migration destination node devices in communication with a source node device;

FIG. 2 illustrates a simplified block diagram of at least one embodiment of an environment of multi-tiered VMs for migration from a source node device of the system FIG. 1;

FIG. 3 is a simplified flow diagram of at least one embodiment of a method for performing a VM migration that may be executed by a virtual machine monitor of the source node device of FIG. 2;

FIG. 4 is a simplified flow diagram of at least one embodiment of a method for performing a pseudo-migration process to identify a VM for migration that may be executed by the virtual machine monitor of the source node of FIG. 2;

FIGS. 5 and 6 are a simplified flow diagram of at least one embodiment of a method for performing a migration a VM from the source node of FIG. 2 to a destination node;

FIG. 7 is a simplified illustration of memory transfer data blocks and migration downtime during a pre-copy and stop-and-copy phase over time of a VM during a VM migration; and

FIG. 8 is a simplified illustration of emulated memory transfer data blocks during a pseudo-migration process.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any tangibly-embodied combination thereof. The disclosed embodiments may also be implemented as instructions carried by or stored on one or more non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

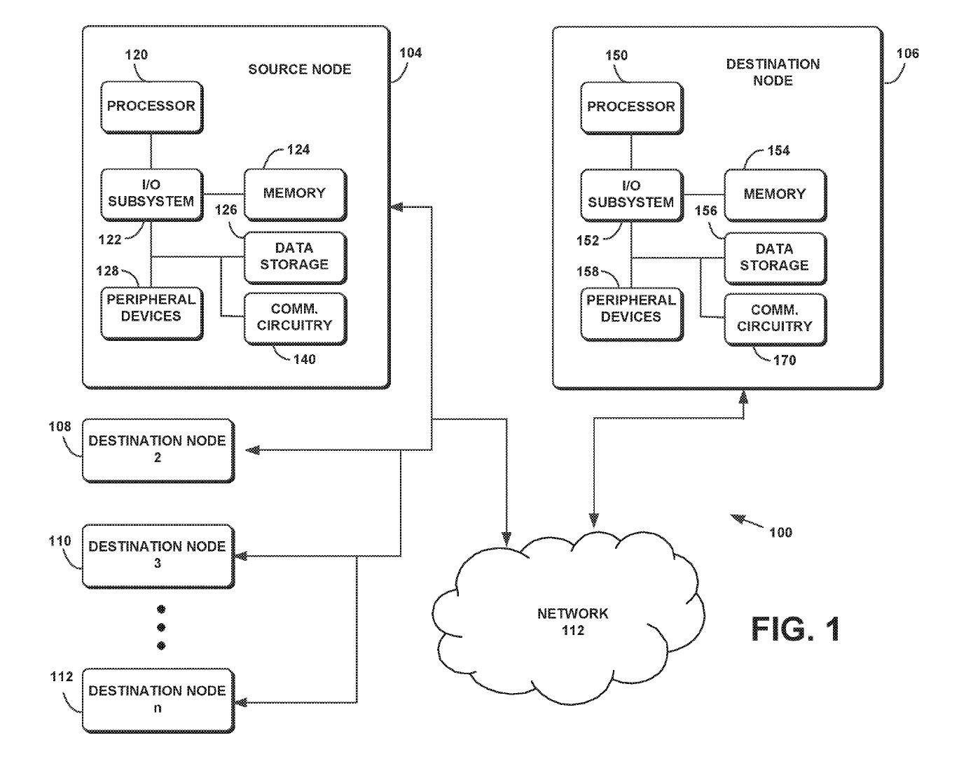

Referring now to FIG. 1, in an illustrative embodiment, a system 100 for migrating virtual machines (VMs) includes one or more destination nodes 106-112 and at least one source node 104, each of which may be capable of communicating with each other over a network 112 using packet-switched or other suitable communications. In use, the source node 104 is configured to select one or more VMs for migration to any one of the destination nodes 106-112 or other area of the source node 104 itself (i.e., the source node 104 may also be a destination node in some embodiments). To do so, as discussed in more detail below, the source node 104 may identify a set of lower-tiered VMs for migration, while leaving higher-tiered VMs in place on the source node 104 such that the impact of live migration performance loss on the higher-tiered VM is avoided or mitigated. The source node 104 may subsequently select a VM from the subset of lower-tiered VMs for migration based on an analysis of an associated static or dynamic working set of each of the lower-tiered VMs. The static working set of a VM is the VM's working set as identified based on static information, such as historical or known information. To select the VM based on the associated static working set, the source node 104 may determine the static working set of each of the lower-tiered VMs based on known or historical workload characteristics of each VM. The source node 104 may then select the VM having the static working set that indicates the smallest impact to the resources of the source node 104 during a proposed migration. For example, the static working set may identify or be indicative of the amount of memory, time, or other resource required to perform the migration of each VM. By selecting the lower-tiered VM having the smallest resource impact, as defined by the static working set, the impact of the migration on the performance of the source node 104 and the system 100 as a whole may be reduced as discussed below.

Alternatively, the source node 104 may select the VM for possible migration based on a dynamic working set associated with VM. To do so, the source node 104 may determine the dynamic working set of each lower-tiered VM by performing a pseudo-migration of the lower-tiered VM in question (or on all identified lower-tiered VMs). The dynamic working set of a VM is the VM's working set as identified based using the pseudo-migration process discussed below, which identifies the working set of the corresponding VM duing a particular time interval. During the pseudo-migration process, as discussed in more detail below, the transfer of memory pages of the associated VM is emulated to identify the magnitude of dirty pages likely to result during a live migration of the associated VM at that point in time. That is, the source node 104 analyzes the likely impact of a live migration of the associated VM without actually transferring the memory pages of the associated VM. The pseudo-migration process may be applied to any one or more of the identified lower-tiered VMs and may be applied periodically (e.g., run for 5 seconds every 5 minutes) or selectively (e.g., activated when resource utilization is above a predetermined threshold, suggesting that a live migration is about to happen) such that a current level of impact (i.e., likely number of dirty page count) can be ascertained. The source node 104 may then select the VM having the dynamic working set that indicates the smallest impact to the resources of the source node 104 during a proposed migration as determined by the pseudo-migration process and proceed with a live migration of the selected VM if desired.

The source node 104 of FIG. 1 may be embodied as any type of computing device capable of performing the functions described herein. For example, the source node 104 may be embodied as, but is not limited to, a server, a computer, a desktop computer, a personal computer (PC), a tablet computer, a laptop computer, a notebook computer, a server computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data, and further configured to perform digital data migration over a network.

In the illustrative embodiment of FIG. 1, the source node 104 includes a processor 120, an I/O subsystem 122, a memory 124, a data storage 126, and communication circuitry 140, which may comprise a network interface controller (NIC) along with any number of devices and circuitry for enabling communications between source node 104 and one or more other external electronic devices and/or systems. The processor 120 may be embodied as any type of processor capable of performing the functions described herein. For example, the processor 120 may be embodied as a single or multi-core processor(s), digital signal processor, microcontroller, or other processor or processing/controlling circuit. Similarly, the memory 124 may be embodied as any type or number of volatile or non-volatile memory or data storage currently known or developed in the future and capable of performing the functions described herein. In operation, the memory 124 may store various data and software used during operation of destination node 106 such as operating systems, applications, programs, libraries, and drivers. In some embodiments, the memory 124 and/or the data storage 126 has stored therein one or more application programs, and the processor 120 is operable to execute the one or more application programs and control a display screen to display corresponding graphical information thereon. Of course, the source node 104 may include other or additional components, such as those commonly found in a digital apparatus and/or computer (e.g., various input/output devices), in other embodiments.

In the illustrative embodiment, the memory 124 is communicatively coupled to the processor 120 via one or more communication links (i.e., point-to-point links, bus links, wires, cables, light guides, printed circuit board traces, etc.). The memory 124 may also be communicatively coupled to the processor 120 via the I/O subsystem 122, which may be embodied as circuitry and/or components to facilitate input/output operations with the processor 120, the memory 124, and other components of source node 104. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with processor 120, memory 124, and other components of source node 104, on a single integrated circuit chip.

The communication circuitry 140 of the source node 104 may be embodied as any type of communication circuit, device, or collection thereof, capable of enabling communications between the source node 104 and other computing devices via one or more communication networks (e.g., local area networks, personal area networks, wide area networks, cellular networks, a global network such as the Internet, etc.). The communication circuitry 140 may be configured to use any one or more communication technologies (e.g., wireless or wired communications) and associated protocols (e.g., Ethernet, Wi-Fi®, WiMAX, etc.) to effect such communication. The communication circuitry 170 may include or be otherwise communicatively coupled to a port or communication interface. The port may be configured to communicatively couple the source node 104 to any number of other computing devices and/or networks (e.g., physical or logical networks).

In some embodiments, the source node 104 may also include one or more peripheral devices 128. The peripheral devices 128 may also include a display, along with associated graphics circuitry and, in some embodiments, may further include a keyboard, a mouse, audio processing circuitry (including, e.g., amplification circuitry and one or more speakers), and/or other input/output devices, interface devices, and/or peripheral devices.

The system 100 of FIG. 1 also includes one or more destination nodes 106-110 as discussed above. Each of the destination nodes 106-110 may be configured similarly as the source node 104. As can be seen from FIG. 1, the destination node 106 includes processor 150, I/O subsystem 152, memory 154, data storage 156, and communication circuitry 170, which may comprise a network interface controller (NIC) along with any number of devices and circuitry for enabling communications between the destination node 106 and one or more other external electronic devices and/or systems. The processor 150 may be embodied as any type of processor capable of performing the functions described herein. In the illustrative embodiment, the memory 154 is communicatively coupled to the processor 150 via one or more communication links (i.e., point-to-point links, bus links, wires, cables, light guides, printed circuit board traces, etc.). The memory 154 may also be communicatively coupled to the processor 150 via the I/O subsystem 152, which may be embodied as circuitry and/or components to facilitate input/output operations with the processor 150, the memory 154, and other components of destination node 106.

The communication circuitry 170 of the destination node 106 may be embodied as any type of communication circuit, device, or collection thereof, capable of enabling communications between the destination node 106 and other computing devices via one or more communication networks (e.g., local area networks, personal area networks, wide area networks, cellular networks, a global network such as the Internet, etc.). The communication circuitry 170 may be configured to use any one or more communication technologies (e.g., wireless or wired communications) and associated protocols (e.g., Ethernet, Wi-Fi®, WiMAX, etc.) to effect such communication. The communication circuitry 170 may include or be otherwise communicatively coupled to a port or communication interface. The port may be configured to communicatively couple the destination node 106 to any number of other computing devices and/or networks (e.g., physical or logical networks).

In the illustrated embodiment, communication between destination nodes 106-110 and the source node 104 takes place via network 112. In an embodiment, the network 112 may represent a wired and/or wireless network and may be or include, for example, a local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). Generally, the communication circuitry 170 of the destination node 106 and the communication circuitry 140 of source node 104 may be configured to use any one or more, or combination, of communication protocols to communicate with each other such as, for example, a wired network communication protocol (e.g., TCP/IP), a wireless network communication protocol (e.g., Wi Wi-Fi®, WiMAX), a cellular communication protocol (e.g., Wideband Code Division Multiple Access (W-CDMA)), and/or other communication protocols. As such, the network 112 may include any number of additional devices, such as additional computers, routers, and switches, to facilitate communications between destination node 106 and source node 104.

It should be understood by those skilled in the art that use of the terms “source node” and “destination node” are for illustrative purposes only, and for providing a point of reference for data migration. As an example, data migration may be configured to migrate information from the source node 104 to the destination node 106 and/or any of destination nodes 106-112. However, depending on the configuration of the system 100, data migration may be configured to migrate information from the destination node 106 to the source node 104, in which case the destination node 106 may be treated as a “source node” and the source node 104 may be treated as a “destination node.” Similarly, in another example, when migrating data from the destination node 106 to the destination node 108, the destination node 106 may be treated as a “source node” and the destination node 108 may be treated as a “destination node.” Moreover, data migration may take place within the same node (e.g., source node 104), in which case the node is both a “source node” and a “destination node”.

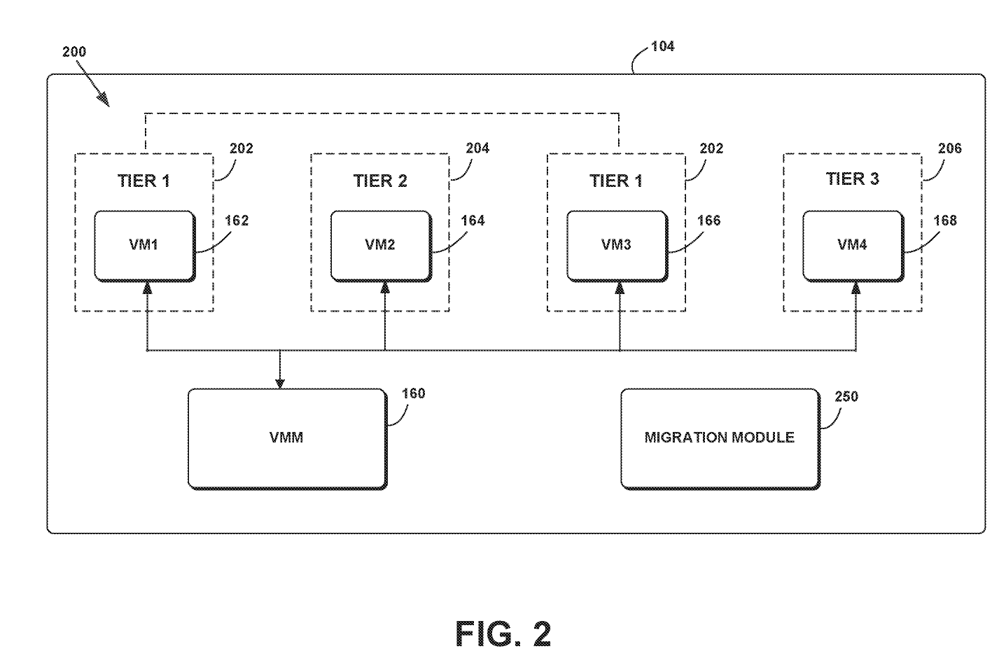

Referring now to FIG. 2, an illustrative environment 200 of a network node, such as a source node 104 or destination node 106, includes a virtual machine monitor 160, a plurality of VMs (162-168) operating in a multi-tiered environment (e.g., tier 1-tier 3), and a migration module 250. In some illustrative embodiments, the virtual machine monitor 160 may be embodied as computer software, firmware or hardware that creates, controls and/or runs VMs in source node 104 and/or any of the destination nodes 106-112. In use, the virtual machine monitor 160 may operate as a host machine, and each VM (162-168) may operate as a guest machine. The virtual machine monitor 160 may present the guest operating systems with a virtual operating platform and manage the execution of the guest operating systems. In some illustrative embodiments, multiple instances of a variety of operating systems may share a virtualized hardware resource. The virtual machine monitor 160 may be embodied as a native hypervisor (type 1) and run directly on the host hardware to control the hardware and to manage guest operating systems. Alternately or in addition, the virtual machine monitor 160 may run on an operating system (type 2), similar to other computer programs.

In some illustrative embodiments, the VMs 162-168 may be configured to emulate computer system functions and operate based on the computer architecture and function of a real or hypothetical computer. The VMs 162-168 may be configured as system virtual machines (or “full virtualization VM”) to provide a complete substitute for a targeted real machine and a level of functionality required for the execution of a complete operating system. Alternately or in addition, the VMs 162-168 may be configured as process virtual machines designed to execute a single computer program by providing an abstracted and platform-independent program execution environment. In some illustrative embodiments, virtualization of the VMs 162-168 may be based on native execution, allowing direct virtualization of the underlying raw hardware and providing multiple instances of the same architecture a real machine may be based on, and capable of running complete operating systems. In other illustrative embodiments, the VMs 162-168 may emulate different architectures and allow execution of software applications and operating systems written for another CPU or architecture. In further illustrative embodiments, the VMs 162-168 may be based on operating system-level virtualization to allow resources of a computer to be partitioned via a kernel's support for multiple isolated user space instances (or “containers”).

In the illustrative embodiment of FIG. 2, the VM1 162 and the VM3 166 both function under the lowest tier 1 (202), while the VM2 164 functions in a lower tier 2 (204), and the VM4 168 functions under the highest tier 3 (206). In this example, the VM4 168 may be fully loaded with high-performance computing (HPC) applications that intensively update a wide range of memory pages. The VM1 162, VM2 164, and VM3 166 have much lower memory utilization, although they may consume other system resources (e.g., CPUs, external devices, etc.) in the meantime. In this scenario, a migration may be required such that the VM4 168 is still capable of meeting its tier 3 service requirements. Accordingly, the environment 200 is configured such that VMs are migrated to another machine from a lowest (e.g., VM1, VM3) to lower (e.g., VM2) tier selection (e.g., if the lowest tier VMs cannot be migrated), instead of migrating the highest-tiered VM (e.g., VM4) as discussed in more detail below.

The migration module 250 controls the migration of VMs from the source node 104. The migration module 250 may be embodied as firmware, software, hardware, or a combination thereof. For example, the migration module 250 and other components of the environment 200 may form a portion of, or otherwise be established by, the processor 120, the I/O subsystem 122, an SoC, or other hardware components of the source node 104. As such, in some embodiments, any one or more of the modules of the environment 200 may be embodied as a circuit or collection of electrical devices (e.g., a migration circuit, etc.). Additionally, in some embodiments, a portion of the migration module 250 may be embodied as a portion of a high level tool stack (e.g., OpenStack) established on the source node 104.

The migration module 250 is configured to identify a set of lower or lowest tiered VMs for possible migration and select a VM from the identified set based on the static and/or dynamic working set associated with each of the identified lower or lowest-tiered VMs. In the illustrative example of FIG. 2, since VM1 162 and VM3 166 are both at the lowest tier (tier 1), the migration module 250 will select the tier 1 VM having the working set that indicates the smallest resource impact for possible migration. As discussed above, the working set information for each VM may be obtained statically by collecting the VM's historical workload characteristics and storing them in a database. In the illustrative embodiment, the working set defines the amount of memory that one or more processes require for use in a given time interval. Similarly, in the illustrative embodiment, a writable working set (WWS) defines the certain set of memory pages that are continuously updated during a pre-copy phase so it cannot be successfully migrated in a pre-copy phase. For example, if the VM3 166 is dedicated to running memory-intensive applications (e.g., SPECjbb), the working set will be high, which, in turn, would flag VM3 166 as not suitable/recommended for live migration in a migration knowledge database.

As discussed above, the migration module 250 may alternatively select or identify a VM for migration based on its dynamic working set, which is determined by implementing a pseudo-migration process on each VM of the identified lower or lowest tier (tier 1 or tier 2 in the example of FIG. 2). During the pseudo-migration, a pre-copy phase of a live migration is emulated to produce an emulated dirty page log, which may be updated as though the VM were undergoing a real live migration. The number of dirty pages identified in the dirty page log is monitored, the dirty page log is cleared, and the emulated pre-copy phase is repeated on any identified updated memory pages. In this way, the likely total number of dirty pages, total number of likely required iterations, and overall likely bandwidth required to perform a live migration of the associated VM may be determined and analyzed relative to other VMs of the same lower tier. The dirty page log may be embodied as any type of data structure capable of recording the identity of dirty memory pages (i.e., memory pages that have been modified).

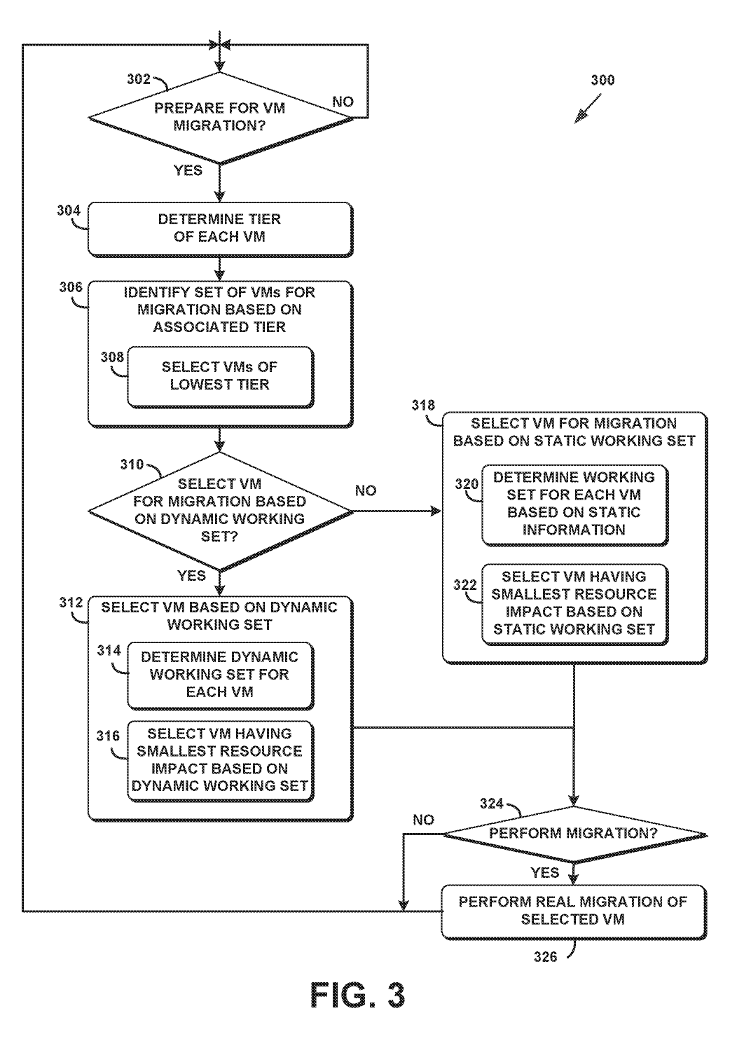

Referring now to FIG. 3, in use, the source node 104 (e.g., the migration module 250) may execute a method 300 for performing a migration of a VM hosted on the source node 104. The method 300 begins with block 302 in which the source node 104 determines whether to prepare for a VM migration. For example, the source node may periodically prepare for VM migration (e.g., periodically monitor the static and/or dynamic working set of lower or lowest tier VMs) or prepare or VM migration in response to so criteria or event (e.g., the utilization of the source node 104 reaching a threshold level). Regardless, if the source node 104 determines to prepare for a VM migration, the method 300 advances to block 304. In block 304, the source node 104 identifies the current tier of each hosted VM (e.g., tier 1-tier 3 of the embodiment illustrated in FIG. 2). Subsequently, in block 306, the source node 104 identifies a set of the hosted VMs based for possible migration based on the tier associated with each VM. The set of hosted VMs may include one or more VMs. For example, in block 308, the source node 104 selects each VM of the lower or lowest available tier (e.g., tier 1 VMs 162 and 166 of FIG. 2). Of course in some embodiments, the VMs of the lowest tiers may not be suitable for migration. In such embodiments, the source node 104 may select the VMs of the lowest tier suitable for VM migration and may refine such selection over time based on the results of the method 300 (e.g., based on the determined dynamic working set of each VM). As such, the VMs operating at the lower or lowest tiers are identified and initially selected to the exclusion of VMs operating at higher tiers (e.g., VMs 164 and 168 of FIG. 2). In this way, the higher tiered VMs are allowed to continue operation without interruption of service, which may allow such VMs to achieve the desired service associated with the higher tiers.

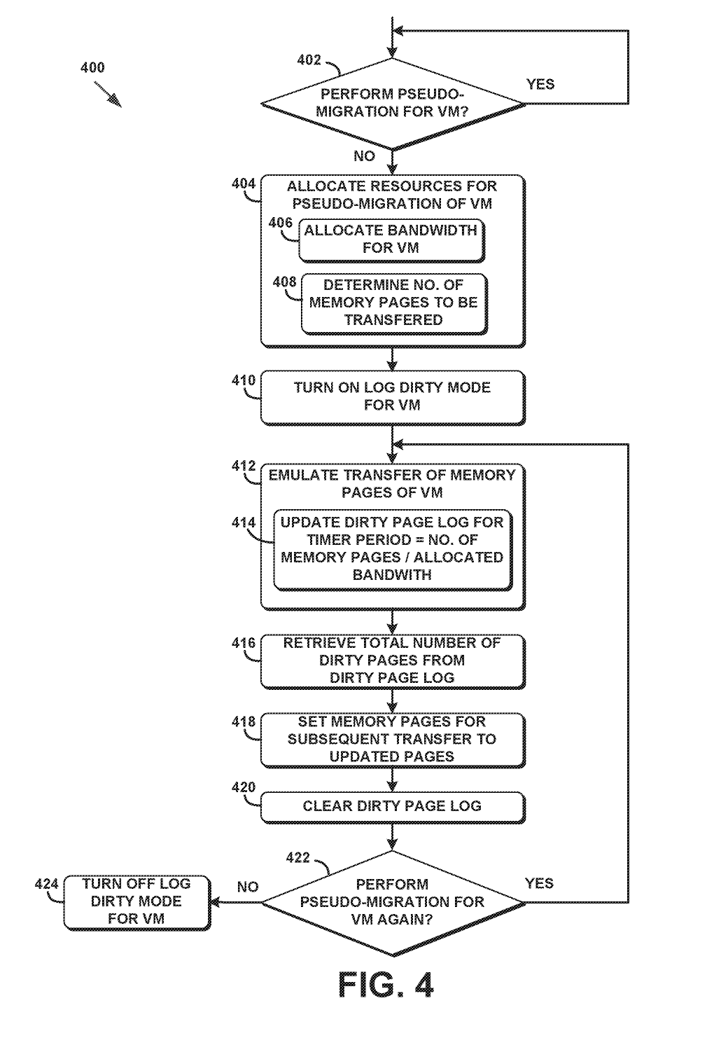

Subsequently, in block 310, the source node 104 determines whether to select a VM for migration based on the dynamic working set associated with each VM or based on a static working set associated with each VM. If the source node 104 determines to select the VM based on the dynamic working set of each VM, the method 300 advances to block 312. In block 312, the source node 102 selects the VM of the set of lower or lowest tier VMs based on the dynamic working set associated with each VM. To do so, the source node 104 determines a the dynamic working set of each VM of the set of lower or lowest tier VMs by applying a pseudo-migration process on each of the lower or lowest tier VMs in block 314. An illustrative embodiment of a pseudo-migration method 400 is illustrated in and discussed below in regard to FIG. 4. It should be appreciated that although the application of the pseudo-migration process is illustrated in FIG. 3 as occurring in block 312, the source node 104 may periodically, occasionally, or selectively execute the pseudo-migration method for any one or more of the identified lower or lowest tiered VMs. For example, the source node 104 may execute the pseudo-migration method for each of the lower or lowest tiered VMs identified in block 306 in parallel with the execution of the remaining blocks of method 300, such that the dynamic working set information generated from the pseudo-migration method for each of the associated lower or lowest tiered VMs is available at block 312. For example, as discussed above, the source node 104 may execute the pseudo-migration method every five minutes or in response to the utilization of the source node 104 reaching a reference threshold. As such, it should be appreciated that the pseudo-migration method 400 discussed below in regard to FIG. 4 may be performed asynchronously with the execution of the method 300 of FIG. 4.

Subsequently, in block 316, the source node 104 selects the VM having the smallest resource impact on the source node 104, as defined by its associated dynamic working set, for possible migration. That is, the source node 104 identifies which dynamic working set of the VMs of the set of lower or lowest tier VMs provides an indication of the smallest resource impact (e.g., in terms of memory resources, migration time, number of migration iterations, number of dirty pages identified, etc.) due to migration of the associated VM. As such, the source node 104 selects the VM that is likely to have the smallest impact on the platform of the source node 104 in block 316, which may increase efficiency of any subsequent live migration and/or reduce performance loss for higher tier VMs operating on the source node 104. After the source node 104 has selected the VM for possible migration based on the dynamic working set, the method 300 advances to block 324 in which the source node 104 determines whether to perform a live migration as discussed in more detail below.

Referring back to block 310, if the source node 104 instead determines to select the VM based on the static working set of each VM, the method 300 advances to block 318. In block 318, the source node 102 selects the VM of the set of lower or lowest tier VMs based on the static working set associated with each VM. To do so, the source node 104 determines the working set of each VM of the set of lower or lowest tier VMs based on static information in block 320. Such static information may include, but is not limited to, known or historical workload characteristics of the associated VMs, which may be recorded over time in an associated database. Subsequently, in block 322, the source node 104 selects the VM having the smallest resource impact on the source node 104, as defined by its associated static working set, for possible migration. That is, the source node 104 identifies which static working set of the VMs of the set of lower or lowest tier VMs provides an indication of the lowest resource impact (e.g., in terms of memory resources, migration time, number of migration iterations, number of dirty pages identified, etc.) due to migration of the associated VM. As such, the source node 104 selects the VM that is likely to have the smallest impact on the platform of the source node 104 in block 322.

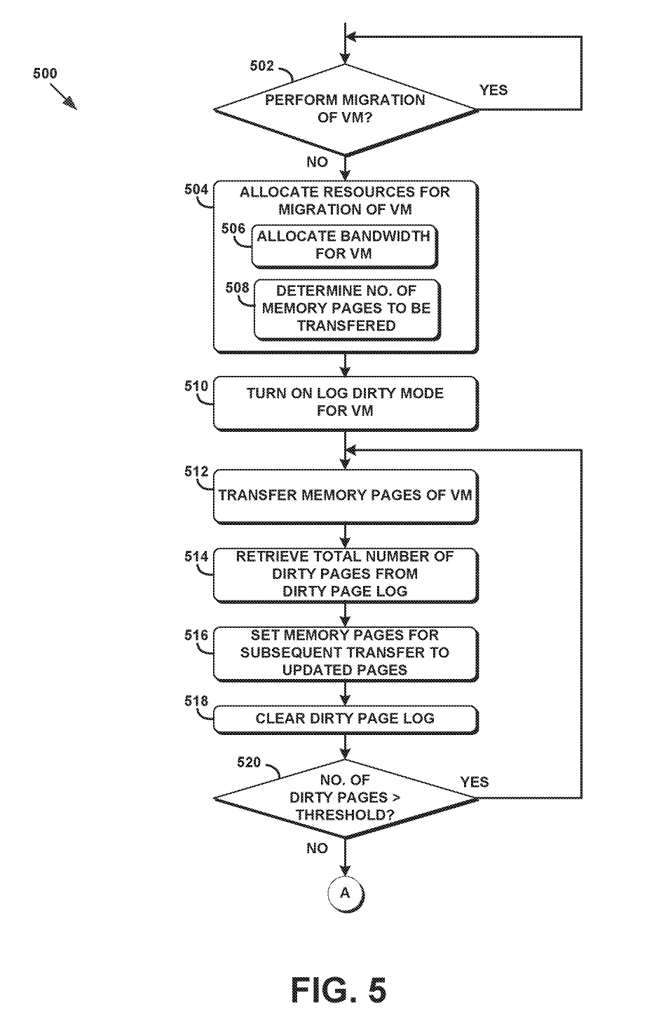

After the source node 104 has selected the VM for possible migration based on the associated dynamic working set in block 312 or based on the associated static working set in block 318, the method 300 advances to block 324. In block 324, the source node 104 determines whether to perform a live migration of the selected VM. That is, in some embodiments, the source node 104 may execute the method 300 to identify the preferable VM (i.e., the lowest tiered VM having the smallest resource impact during a proposed migration) in preparation of a VM migration, without actually performing the live migration at that time. If the source node 104 determines to perform the live migration, the method 300 advances to block 324. In block 324, the source node 104 performs the live migration of the selected VM. To do so, the source node 104 may execute a method 500 to perform a live migration as illustrated in and discussed below in regard to FIGS. 5 and 6.

However, if the source node 104 determines not to perform the live migration in block 3244, the method 300 loops back to block 302 in which the source node 104 again determines whether to prepare for VM migration. In this way, the source node 104 may periodically, selectively, or continually update the selected VM for migration in anticipation of performing a live migration at some point in the future.

Referring now to FIG. 4, as discussed above, the source node 104 (e.g., the migration module 250) may periodically or selectively execute a method 400 for performing a pseudo-migration process on one or more selected VMs to determine a dynamic working set of the associated VM. The method 400 begins with block 402 in which the source node 104 determines whether to perform the pseudo-migration on a selected VM. As discussed above, the source node 104 may perform the pseudo-migration periodically or selectively on any one or more of the identified lower or lowest tiered VMs.

If the source node 104 determines to perform the pseudo-migration, the method 400 advances to block 404 in which the source node 104 allocates resources for the pseudo-migration of the selected VM. For example, in block 406, the source node 104 may allocate bandwidth of the migration of the VM. Additionally, in block 408, the source node 104 may determine the initial number of memory pages associated with the VM to be transferred. Typically, the source node 104 may set the initial number of memory pages to be transferred to the entire guest memory pages of the selected VM.

Subsequently, in block 410, the source node 104 turns on the log dirty mode for the selected VM. As discussed above, the log dirty mode enables the source node (e.g., the migration module 250) to record, indicate, or otherwise identify those memory pages that have been modified during the migration process, which may require another pass to successfully transfer (in a live migration). In block 412, the source node 104 emulates the transfer of memory pages of the selected VM. That is, the source node 104 emulates a live migration process in block 412 without actually transfer the memory pages of the selected VM. During the emulation of the migration process of block 412, the enabled dirty log mode causes the source node 104 to update the dirty page log (e.g., a bitmap or other logging data structure) with the identified “dirty memory pages” for a defined reference period of time in block 414. That is, the source node 104 emulates the transfer of memory pages by monitoring and recording those memory pages that are modified during the monitored reference period of time, without actually performing any transfer of memory pages. Illustratively, the reference period of time is set to a time period equal to, or otherwise similar to, the number of memory pages to be transferred (which may change over time) divided by the allocated bandwidth. Of course, other reference periods may be used in other embodiments.

After completion of the emulated transfer of memory pages in block 412, the source node 104 determines or retrieves the total number of “dirty” memory pages from the dirty page log. In block 418, the source node 104 sets the number of memory pages for subsequent transfer to the number of identified “dirty” memory pages. Subsequently, in block 420, the source node 104 clears the dirty page log and determines whether to perform the pseudo-migration again for the selected VM. If not, the method 400 advances to block 424 in which the log dirty mode is disabled for the selected VM. If, however, the source node 104 determines to repeat the emulation of the transfer of memory pages (e.g., there are a number of dirty memory pages greater than a threshold), the method 400 loops back to block 412 to repeat the transfer of memory pages on the updated, previously “dirty” memory pages. That is, the source node 104 may repeatedly emulate the transfer of memory pages until no “dirty” memory pages are identified. In this way, the source node 104 is capable of determining the likely number of memory page transfer iterations required to fully transfer the selected VM at that particular point in time. Of course, additional dynamic working set information may also be obtained from the method 400, such as the likely total number of “dirty” memory pages likely to occur during the live migration of the selected VM, the general resource requirements to perform such live migration, and so forth. Additionally, as discussed above in regard to FIG. 3, the source node 104 may utilize such dynamic working set information to select the VM for live migration.

Referring now to FIGS. 5 and 6, in use, the source node 104 (e.g., the migration module 250) may execute a method 500 to perform a live migration of a selected VM. The method 500 may be executed, for example, as part of block 324 of method 300. The method 500 begins with block 502 in which the source node 104 determines whether to perform a migration of a selected VM. As discussed above, the source node 104 may determine to perform a migration in response to any suitable criteria such as the processor 120 utilization reaching a threshold level. Regardless, if the source node 104 determines to perform the live migration, the method 500 advances to block 504 in which the source node 104 allocates resources for the live migration of the selected VM. For example, in block 506, the source node 104 may allocate bandwidth of the migration of the VM. Additionally, in block 508, the source node 104 may determine the initial number of memory pages associated with the VM to be transferred. As discussed above, the source node 104 may set the initial number of memory pages to be transferred to the entire guest memory pages of the selected VM.

Subsequently, in block 510, the source node 104 turns on the log dirty mode for the selected VM. In block 512, the source node 104 transfers the memory pages of the selected VM to the desired destination (e.g., destination node 106-112). After completion of the transfer of memory pages in block 512, the source node 104 determines or retrieves the total number of “dirty” memory pages from the dirty page log in block 514. In block 516, the source node 104 sets the memory pages for subsequent transfer to the identified “dirty” memory pages. Subsequently, in block 518, the source node 104 clears the dirty page log.

In block 520, the source node 104 determines whether the number of identified “dirty” memory pages is greater than a threshold reference. If so, the method 500 loops back to block 512 in which the identified “dirty” memory pages are transferred again to the destination node. If, however, the number of identified “dirty” memory pages is less than the threshold reference, the method 500 advances to block 522 of FIG. 6 (i.e., the stop-and-copy phase of the live migration). In block 522, the identified VM is suspended and any remaining data (e.g., remnant dirty memory pages) is transferred to the destination node. In addition to the memory pages, other data, such as CPU and device states may be transferred as well. Subsequently, in block 524, the target VM is woken up on the destination node to complete the live migration. In block 526, the log dirty mode is disabled and the selected VM is wiped from the source node 104.

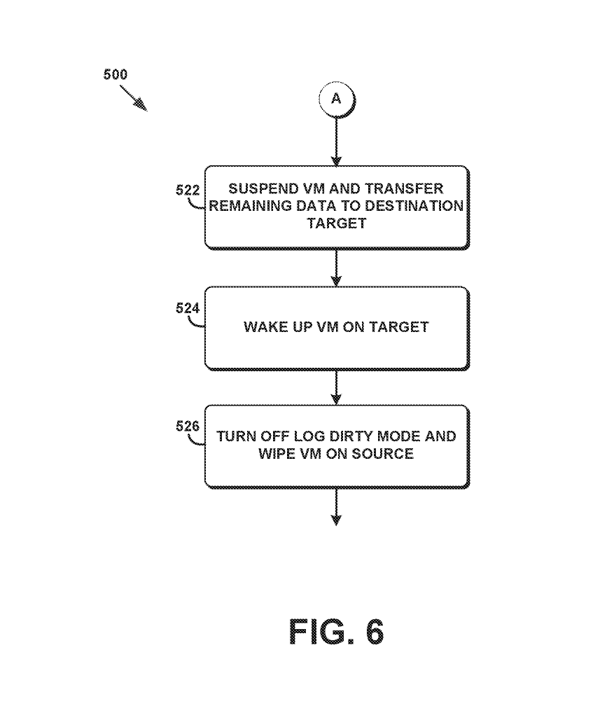

Referring now to FIG. 7, an example of a real migration overhead diagram is shown. The overhead diagram of FIG. 7 may be illustrative of a real migration process, such as the illustrative embodiment of method 500 of FIGS. 5 and 6. At the beginning of a pre-copy phase, a bitmap update 702 (or other logging data structure) is conducted, followed by a memory transfer of pages 704 during a first round of transfer (“round 1”). If the collected dirty pages exceed a predetermined threshold, another bitmap update 706 is conducted, followed by a memory transfer 608 in a second round (“round 2”). The process may repeat until a final round (“round n”), where, after bitmap update 710 and memory transfer 712 is completed, there is a sufficiently small number of dirty pages to allow the real migration process to proceed to the stop-and-copy phase (e.g., see FIG. 6), where migration downtime overhead 714 is shown when the VM is suspended or stopped.

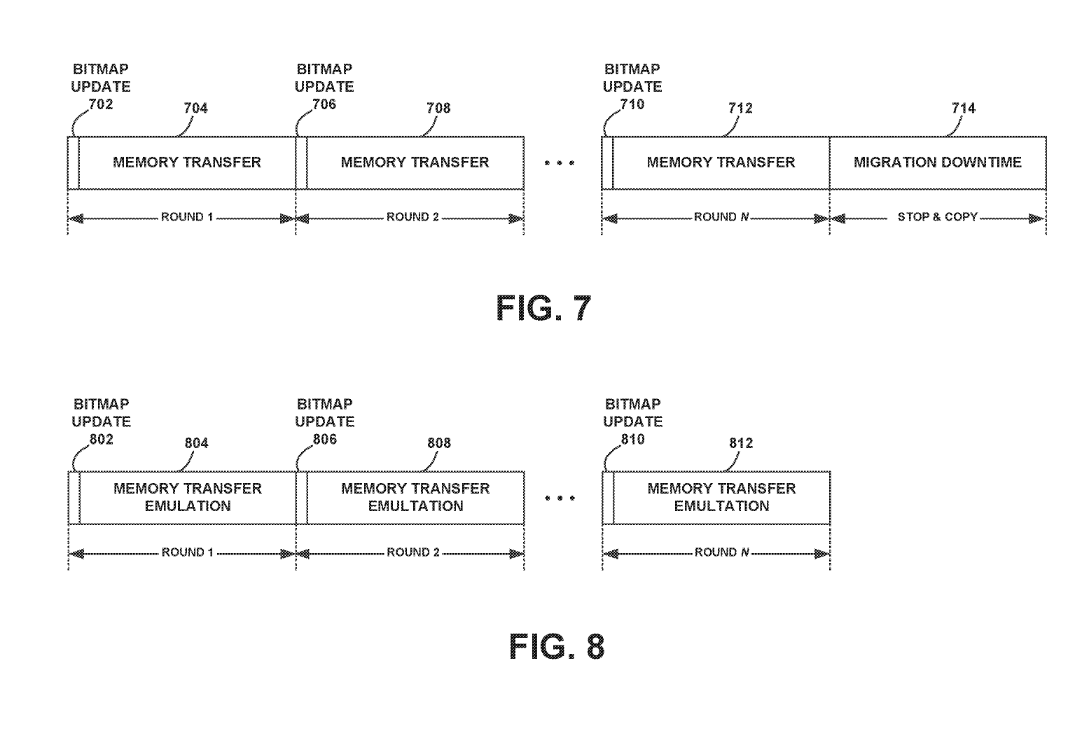

Referring now to FIG. 8, an example of a pseudo-migration overhead diagram is shown. The overhead diagram of FIG. 8 may be illustrative of a pseudo-migration process, such as the illustrative embodiment of method 400 of FIG. 4. The pseudo-migration begins by emulating a pre-copy phase, where a bitmap update 802 is conducted, followed by an emulated memory transfer of pages 804 during a first round of transfer (“round 1”). After collecting dirty pages, and if pseudo-migration control remains active, another bitmap update 806 is conducted, followed by another emulated memory transfer 808 in a second round (“round 2”). The process may repeat until the pseudo-migration control deactivated (e.g., by an expiration of time or presence/absence of a feature), where, prior to the deactivation, a final round (“round n”) is performed, where a final bitmap update 810 and emulated memory transfer 812 is completed. It can be appreciated by those skilled in the art that the memory transfer latency from real live migration (e.g., 704, 708, and 712) causes excessive overhead and will be further affected by the amount of update (“dirty”) pages and the network bandwidth allocated to the migration process. As the presently disclosed pseudo-migration mechanism merely updates dirty bitmap processes and emulates memory transfer, and thus does not contribute significantly to overhead.

### EXAMPLES

Illustrative examples of the technologies disclosed herein are provided below. An embodiment of the technologies may include any one or more, and any combination of, the examples described below.

Example 1 includes a source node for managing migration of a virtual machine to a destination node, the source node comprising a virtual machine monitor to establish each virtual machine of a plurality of virtual machines at a corresponding tier of a plurality of quality-of-service tiers, wherein the plurality of quality-of-service tiers includes a highest tier and at least one lower tier; and a migration module to (i) identify a set of the virtual machines of the plurality of virtual machines based on the tier associated with each virtual machine, wherein each virtual machine of the set of virtual machines has the at least one lower tier associated therewith, (ii) perform a pseudo-migration for each of the virtual machines of the set of virtual machines, wherein to perform the pseudo migration comprises to emulate a pre-copy phase of a corresponding live migration to determine a dynamic working set of the corresponding virtual machine, and (iii) select a virtual machine of the set of virtual machines for live migration based on the dynamic working set associated with each virtual machine of the set of virtual machines.

Example 2 includes the subject matter of Example 1, and to identify the set of the virtual machines comprises to select those virtual machines of the plurality of virtual machines having the lowest tier associated therewith.

Example 3 includes the subject matter of any of Examples 1 and 2, and wherein to perform the pseudo-migration comprises to emulate a transfer of memory pages of the corresponding virtual machine; identify a number of dirty memory pages associated with the corresponding virtual machine in response to the emulation of the transfer of memory pages.

Example 4 includes the subject matter of any of Examples 1-3, and wherein to identify the number of dirty memory pages comprises to provide an indication of each dirty memory page in a dirty page log.

Example 5 includes the subject matter of any of Examples 1-4, and wherein the dynamic working set comprises the number of dirty memory pages.

Example 6 includes the subject matter of any of Examples 1-5, and wherein to select the virtual machine comprises to select the virtual machine of the set of virtual machines having the smallest number of dirty memory pages associated therewith.

Example 7 includes the subject matter of any of Examples 1-6, and wherein to emulate the transfer of memory pages comprises to emulate the transfer of memory pages for a reference period of time.

Example 8 includes the subject matter of any of Examples 1-7, and wherein the migration module is further to emulate a subsequent transfer of the memory pages of the corresponding virtual machine that have been identified as dirty memory pages; and update the number of dirty memory pages associated with the virtual machine in response to the subsequent transfer of memory pages.

Example 9 includes the subject matter of any of Examples 1-8, and wherein to emulate the transfer of memory pages comprises to perform a number of iterations of emulations of a transfer of memory pages based on identified dirty memory pages, and wherein the migration module is further to count the total number of iterations of the emulations of the corresponding virtual machine, wherein to select the virtual machine comprises to select a virtual machine of the set of virtual machines based on the total number of iterations of the emulations associated with each virtual machine of the set of virtual machines.

Example 10 includes the subject matter of any of Examples 1-9, and wherein to perform the pseudo-migration comprises to turn on a log dirty mode to record the identity of memory pages that have been modified during the emulation of the pre-copy phase of the corresponding live migration.

Example 11 includes the subject matter of any of Examples 1-10, and wherein to perform the pseudo-migration comprises to periodically perform the pseudo-migration for each of the virtual machines of the set of virtual machines.

Example 12 includes the subject matter of any of Examples 1-11, and wherein to perform the pseudo-migration comprises to perform the pseudo-migration for each of the virtual machines of the set of virtual machines in response to the presence or absence of a reference event of the computing device.

Example 3 includes the subject matter of any of Examples 1-12, and wherein the reference event comprises a level of hardware resource utilization in the computing device.

Example 14 includes the subject matter of any of Examples 1-13, and wherein the reference event comprises a size of a virtualized device queue.

Example 15 includes the subject matter of any of Examples 1-14, and wherein to select the virtual machine comprises to select a virtual machine of the set of virtual machines in response to an amount of resources, identified by the dynamic working set, required to migrate the virtual machine being below a reference amount.

Example 16 includes the subject matter of any of Examples 1-15, and wherein to select the virtual machine comprises to select a virtual machine of the set of virtual machines in response to an amount of resources, identified by the dynamic working set, required to migrate the virtual machine being above a reference amount.

Example 17 includes the subject matter of any of Examples 1-16, and wherein the migration module is further to select a virtual machine of the set of virtual machines for live migration based on a static working set associated with each virtual machine of the set of virtual machines.

Example 18 includes the subject matter of any of Examples 1-17, and wherein the dynamic working set of each virtual machine comprises an amount of memory that one or more processes of the computing device require for use by the corresponding virtual machine in a given time interval.

Example 19 includes the subject matter of any of Examples 1-18, and wherein the dynamic working set of each virtual machine is based at least in part on a total amount of dirty pages determined from each of the emulated pre-copy phase.

Example 20 includes a method for managing migration of a virtual machine from a source node to a destination node, the method comprising establishing, by the source node, each virtual machine of a plurality of virtual machines at a corresponding tier of a plurality of quality-of-service tiers, wherein the plurality of quality-of-service tiers includes a highest tier and at least one lower tier; identifying, by the source node, a set of the virtual machines of the plurality of virtual machines based on the tier associated with each virtual machine, wherein each virtual machine of the set of virtual machines has the at least one lower tier associated therewith; performing, by the source node, a pseudo-migration for each of the virtual machines of the set of virtual machines, wherein performing the pseudo migration comprises emulating a pre-copy phase of a corresponding live migration to determine a dynamic working set of the corresponding virtual machine; and selecting, by the source node, a virtual machine of the set of virtual machines for live migration based on the dynamic working set associated with each virtual machine of the set of virtual machines.

Example 21 includes the subject matter of Example 20, and wherein identifying the set of the virtual machines comprises selecting those virtual machines of the plurality of virtual machines having the lowest tier associated therewith.

Example 22 includes the subject matter of any of Examples 20 and 21, and wherein performing the pseudo-migration comprises emulating a transfer of memory pages of the corresponding virtual machine; identifying a number of dirty memory pages associated with the corresponding virtual machine in response to the emulation of the transfer of memory pages.

Example 23 includes the subject matter of any of Examples 20-22, and wherein identifying the number of dirty memory pages comprises providing an indication of each dirty memory page in a dirty page log.

Example 24 includes the subject matter of any of Examples 20-23, and wherein the dynamic working set comprises the number of dirty memory pages.

Example 25 includes the subject matter of any of Examples 20-24, and wherein selecting the virtual machine comprises selecting the virtual machine of the set of virtual machines having the smallest number of dirty memory pages associated therewith.

Example 26 includes the subject matter of any of Examples 20-25, and wherein emulating the transfer of memory pages comprises emulating the transfer of memory pages for a reference period of time.

Example 27 includes the subject matter of any of Examples 20-26, and further including emulating a subsequent transfer of the memory pages of the corresponding virtual machine that have been identified as dirty memory pages; and updating the number of dirty memory pages associated with the virtual machine in response to the subsequent transfer of memory pages.

Example 28 includes the subject matter of any of Examples 20-27, and wherein emulating the transfer of memory pages comprises performing a number of iterations of emulations of a transfer of memory pages based on identified dirty memory pages, and further comprising counting the total number of iterations of the emulations of the corresponding virtual machine, wherein selecting the virtual machine comprises selecting a virtual machine of the set of virtual machines based on the total number of iterations of the emulations associated with each virtual machine of the set of virtual machines.

Example 29 includes the subject matter of any of Examples 20-28, and wherein performing the pseudo-migration comprises turning on a log dirty mode to record the identity of memory pages that have been modified during the emulation of the pre-copy phase of the corresponding live migration.

Example 30 includes the subject matter of any of Examples 20-29, and wherein performing the pseudo-migration comprises periodically performing the pseudo-migration for each of the virtual machines of the set of virtual machines.

Example 31 includes the subject matter of any of Examples 20-30, and wherein performing the pseudo-migration comprises performing the pseudo-migration for each of the virtual machines of the set of virtual machines in response to the presence or absence of a reference event of the computing device.

Example 32 includes the subject matter of any of Examples 20-31, and wherein the reference event comprises a level of hardware resource utilization in the computing device.

Example 33 includes the subject matter of any of Examples 20-32, and wherein the reference event comprises a size of a virtualized device queue.

Example 34 includes the subject matter of any of Examples 20-33, and wherein selecting the virtual machine comprises selecting a virtual machine of the set of virtual machines in response to an amount of resources, identified by the dynamic working set, required to migrate the virtual machine being below a reference amount.

Example 35 includes the subject matter of any of Examples 20-34, and wherein selecting the virtual machine comprises selecting a virtual machine of the set of virtual machines in response to an amount of resources, identified by the dynamic working set, required to migrate the virtual machine being above a reference amount.

Example 36 includes the subject matter of any of Examples 20-35, and further including selecting, by the source node, a virtual machine of the set of virtual machines for live migration based on a static working set associated with each virtual machine of the set of virtual machines.

Example 37 includes the subject matter of any of Examples 20-36, and wherein the dynamic working set of each virtual machine comprises an amount of memory that one or more processes of the computing device require for use by the corresponding virtual machine in a given time interval.

Example 38 includes the subject matter of any of Examples 20-37, and wherein the dynamic working set of each virtual machine is based at least in part on a total amount of dirty pages determined from each of the emulated pre-copy phase.

Example 39 includes one or more machine-readable media comprising a plurality of instructions stored thereon that, in response to execution by a computing device, causes the source node to perform the method of any of Examples 20-38.

Example 40 includes a source node for managing migration of a virtual machine to a destination node, the source node comprising means for establishing each virtual machine of a plurality of virtual machines at a corresponding tier of a plurality of quality-of-service tiers, wherein the plurality of quality-of-service tiers includes a highest tier and at least one lower tier; means for identifying a set of the virtual machines of the plurality of virtual machines based on the tier associated with each virtual machine, wherein each virtual machine of the set of virtual machines has the at least one lower tier associated therewith; means for performing a pseudo-migration for each of the virtual machines of the set of virtual machines, wherein performing the pseudo migration comprises emulating a pre-copy phase of a corresponding live migration to determine a dynamic working set of the corresponding virtual machine; and means for selecting a virtual machine of the set of virtual machines for live migration based on the dynamic working set associated with each virtual machine of the set of virtual machines.

Example 41 includes the subject matter of Example 40, and wherein the means for performing the pseudo-migration comprises means for emulating a transfer of memory pages of the corresponding virtual machine; means for identifying a number of dirty memory pages associated with virtual machine in response to the emulation of the transfer of memory pages.

Example 42 includes the subject matter of any of Examples 40 and 41, and wherein the means for identifying the number of dirty memory pages comprises means for providing an indication of each dirty memory page in a dirty page log.

Example 43 includes the subject matter of any of Examples 40-42, and wherein the dynamic working set comprises the number of dirty memory pages.

Example 44 includes the subject matter of any of Examples 40-43, and wherein the means for selecting the virtual machine comprises means for selecting the virtual machine of the set of virtual machines having the smallest number of dirty memory pages associated therewith.

Example 45 includes the subject matter of any of Examples 40-44, and wherein the means for emulating the transfer of memory pages comprises means for emulating the transfer of memory pages for a reference period of time.

Example 46 includes the subject matter of any of Examples 40-45, and further including means for emulating a subsequent transfer of the memory pages of the corresponding virtual machine that have been identified as dirty memory pages; and means for updating the number of dirty memory pages associated with the virtual machine in response to the subsequent transfer of memory pages.

Example 47 includes the subject matter of any of Examples 40-46, and wherein the means for emulating the transfer of memory pages comprises means for performing a number of iterations of emulations of a transfer of memory pages based on identified dirty memory pages, and further comprising means for counting the total number of iterations of the emulations of the corresponding virtual machine, wherein means for selecting the virtual machine comprises the means for selecting a virtual machine of the set of virtual machines based on the total number of iterations of the emulations associated with each virtual machine of the set of virtual machines.

1-25. (canceled)

26. A source node for managing migration of a virtual machine to a destination node, the source node comprising:
a virtual machine monitor to establish each virtual machine of a plurality of virtual machines at a corresponding tier of a plurality of quality-of-service tiers, wherein the plurality of quality-of-service tiers includes a highest tier and at least one lower tier; and
a migration module to (i) identify a set of the virtual machines of the plurality of virtual machines based on the tier associated with each virtual machine, wherein each virtual machine of the set of virtual machines has the at least one lower tier associated therewith, (ii) perform a pseudo-migration for each of the virtual machines of the set of virtual machines, wherein to perform the pseudo migration comprises to emulate a pre-copy phase of a corresponding live migration to determine a dynamic working set of the corresponding virtual machine, and (iii) select a virtual machine of the set of virtual machines for live migration based on the dynamic working set associated with each virtual machine of the set of virtual machines.

27. The source node of claim 26, wherein to perform the pseudo-migration comprises to:
emulate a transfer of memory pages of the corresponding virtual machine;
identify a number of dirty memory pages associated with the corresponding virtual machine in response to the emulation of the transfer of memory pages.

28. The source node of claim 27, wherein the dynamic working set comprises the number of dirty memory pages.

29. The source node of claim 28, wherein to select the virtual machine comprises to select the virtual machine of the set of virtual machines having the smallest number of dirty memory pages associated therewith.

30. The source node of claim 27, wherein the migration module is further to:
emulate a subsequent transfer of the memory pages of the corresponding virtual machine that have been identified as dirty memory pages; and
update the number of dirty memory pages associated with the virtual machine in response to the subsequent transfer of memory pages.

31. The source node of claim 27, wherein to emulate the transfer of memory pages comprises to perform a number of iterations of emulations of a transfer of memory pages based on identified dirty memory pages, and wherein the migration module is further to count the total number of iterations of the emulations of the corresponding virtual machine,
wherein to select the virtual machine comprises to select a virtual machine of the set of virtual machines based on the total number of iterations of the emulations associated with each virtual machine of the set of virtual machines.

32. The source node of claim 26, wherein to select the virtual machine comprises to select a virtual machine of the set of virtual machines in response to an amount of resources, identified by the dynamic working set, required to migrate the virtual machine being below a reference amount.

33. The source node of any of claim 26, wherein the dynamic working set of each virtual machine comprises an amount of memory that one or more processes of the computing device require for use by the corresponding virtual machine in a given time interval.

34. The source node of any of claim 26, wherein the dynamic working set of each virtual machine is based at least in part on a total amount of dirty pages determined from each of the emulated pre-copy phase.

35. One or more machine-readable media comprising a plurality of instructions stored thereon that, in response to execution, causes a source node to:
establish each virtual machine of a plurality of virtual machines at a corresponding tier of a plurality of quality-of-service tiers, wherein the plurality of quality-of-service tiers includes a highest tier and at least one lower tier;
identify a set of the virtual machines of the plurality of virtual machines based on the tier associated with each virtual machine, wherein each virtual machine of the set of virtual machines has the at least one lower tier associated therewith;
perform a pseudo-migration for each of the virtual machines of the set of virtual machines, wherein performing the pseudo migration comprises emulating a pre-copy phase of a corresponding live migration to determine a dynamic working set of the corresponding virtual machine; and
select a virtual machine of the set of virtual machines for live migration based on the dynamic working set associated with each virtual machine of the set of virtual machines.

36. The one or more machine-readable media of claim 35, wherein to perform the pseudo-migration comprises to:
emulate a transfer of memory pages of the corresponding virtual machine;
identify a number of dirty memory pages associated with the corresponding virtual machine in response to the emulation of the transfer of memory pages.

37. The one or more machine-readable media of claim 36, wherein the dynamic working set comprises the number of dirty memory pages.

38. The one or more machine-readable media of claim 36, wherein the plurality of instructions, in response to execution, further causes the source node to:
emulate a subsequent transfer of the memory pages of the corresponding virtual machine that have been identified as dirty memory pages; and
update the number of dirty memory pages associated with the virtual machine in response to the subsequent transfer of memory pages.

39. The one or more machine-readable media of claim 36, wherein to emulate the transfer of memory pages comprises to perform a number of iterations of emulations of a transfer of memory pages based on identified dirty memory pages,
wherein the plurality of instructions, in response to execution, further causes the source node to count the total number of iterations of the emulations of the corresponding virtual machine, and
wherein to select the virtual machine comprises to select a virtual machine of the set of virtual machines based on the total number of iterations of the emulations associated with each virtual machine of the set of virtual machines.

40. The one or more machine-readable media of claim 35, wherein to select the virtual machine comprises to select a virtual machine of the set of virtual machines in response to an amount of resources, identified by the dynamic working set, required to migrate the virtual machine having a reference relationship with a reference amount.

41. The one or more machine-readable media of claim 35, wherein the dynamic working set of each virtual machine comprises an amount of memory that one or more processes of the computing device require for use by the corresponding virtual machine in a given time interval.

42. The one or more machine-readable media of claim 35, wherein the dynamic working set of each virtual machine is based at least in part on a total amount of dirty pages determined from each of the emulated pre-copy phase.

43. A method for managing migration of a virtual machine from a source node to a destination node, the method comprising:
establishing, by the source node, each virtual machine of a plurality of virtual machines at a corresponding tier of a plurality of quality-of-service tiers, wherein the plurality of quality-of-service tiers includes a highest tier and at least one lower tier;
identifying, by the source node, a set of the virtual machines of the plurality of virtual machines based on the tier associated with each virtual machine, wherein each virtual machine of the set of virtual machines has the at least one lower tier associated therewith;
performing, by the source node, a pseudo-migration for each of the virtual machines of the set of virtual machines, wherein performing the pseudo migration comprises emulating a pre-copy phase of a corresponding live migration to determine a dynamic working set of the corresponding virtual machine; and
selecting, by the source node, a virtual machine of the set of virtual machines for live migration based on the dynamic working set associated with each virtual machine of the set of virtual machines.

44. The method of claim 43, wherein performing the pseudo-migration comprises:
emulating a transfer of memory pages of the corresponding virtual machine;
identifying a number of dirty memory pages associated with the corresponding virtual machine in response to the emulation of the transfer of memory pages.

45. The method of claim 44, wherein the dynamic working set comprises the number of dirty memory pages.

46. The method of claim 44, further comprising:
emulating a subsequent transfer of the memory pages of the corresponding virtual machine that have been identified as dirty memory pages; and
updating the number of dirty memory pages associated with the virtual machine in response to the subsequent transfer of memory pages.

47. The method of claim 44, wherein emulating the transfer of memory pages comprises performing a number of iterations of emulations of a transfer of memory pages based on identified dirty memory pages, and further comprising counting the total number of iterations of the emulations of the corresponding virtual machine,
wherein selecting the virtual machine comprises selecting a virtual machine of the set of virtual machines based on the total number of iterations of the emulations associated with each virtual machine of the set of virtual machines.

48. The method of claim 43, wherein selecting the virtual machine comprises selecting a virtual machine of the set of virtual machines in response to an amount of resources, identified by the dynamic working set, required to migrate the virtual machine having a reference relationship with a reference amount.

49. The method of claim 43, wherein the dynamic working set of each virtual machine comprises an amount of memory that one or more processes of the computing device require for use by the corresponding virtual machine in a given time interval.

50. The method of claim 43, wherein the dynamic working set of each virtual machine is based at least in part on a total amount of dirty pages determined from each of the emulated pre-copy phase.
